(19) United States
(12) Patent Application Publication
(10) Pub. No.: US 2026/0205369 A1
(43) Pub. Date: Jul. 16, 2026

(54) METHOD FOR RECOMMENDING WEB SERVICE BASED ON GRAPH ATTENTION CONVOLUTIONAL NETWORK AND GRAPH POOLING

(71) Applicants: China Jiliang University, Zhejiang (CN); ZHEJIANG UNIVERSITY OF TECHNOLOGY, Zhejiang (CN)

(72) Inventors: Gang Xiao, Zhejiang (CN); Jiawei Lu, Zhejiang (CN); Zhongcheng XIAO, Zhejiang (CN); Cece Wang, Zhejiang (CN); Zhenbo Cheng, Zhejiang (CN); Chen Li, Zhejiang (CN); Yan ZHU, Zhejiang (CN)

(73) Assignees: China Jiliang University, Zhejiang (CN); ZHEJIANG UNIVERSITY OF TECHNOLOGY, Zhejiang (CN)

(21) Appl. No.: 19/422,366

(22) Filed: Dec. 16, 2025

(30) Foreign Application Priority Data
Jan. 15, 2025 (CN) 202510060709.9

(51) Int. Cl. H04L 41/14; G06F 16/951; G06F 16/958

(52) U.S. Cl. CPC H04L 41/145; G06F 16/951; G06F 16/958

(57) ABSTRACT

Disclosed is a method for recommending a Web service based on a graph attention convolutional network and graph pooling. The method includes: constructing a service network graph based on a dual-tower model, and differentiating a focus service; providing a dual-level aware self-attention mechanism in a graph convolution process, controlling an amount of information aggregated from a source node to a target node in a cluster-aware self-attention mechanism, and controlling an amount of information received by the target node from the source node in a query-aware self-attention mechanism; then, further extracting service information according to a graph pooling method taking a heterogeneous node coarsening strategy as a core; and splicing a dynamic representation, a graph-level representation, and a target service of the focus service, learning a composite embedding representation, and predicting a probability of interaction between the target service and a user at a next moment in a prediction layer.

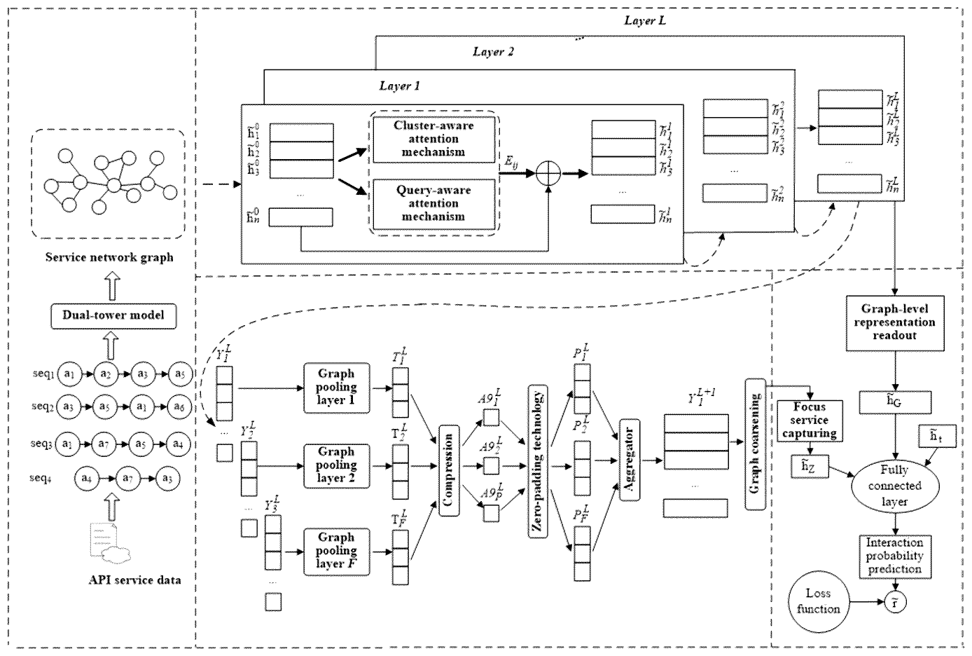

### CROSS-REFERENCE TO RELATED APPLICATION

This application claims the priority benefit of China application serial no. 202510060709.9, filed on Jan. 15, 2025. The entirety of each of the above-mentioned patent applications is hereby incorporated by reference herein and made a part of this specification.

### TECHNICAL FIELD

The present disclosure belongs to the field of service computing, and particularly relates to a method for recommending a Web service based on a graph attention convolutional network and graph pooling.

### BACKGROUND

A service-oriented architecture (SOA), a component model, enables different functional modules of an application to efficiently communicate through well-defined interfaces. A Web service, a core technology for implementing the SOA, is capable of providing specific functions and business logic, and is regarded as a new generation of Web applications. Business-level software is reused through the Web service, thereby significantly optimizing a development process. An application programming interface (API) provides specific functions, the Web service exposes its functions through the API, and other applications are capable of acquiring the functions provided by the Web service by calling the API. With numerous advantages of improvement in flexibility of a software system, reduction of cost, and promotion of business transformation, the API is vigorously growing, which increases a difficulty for a software developer to acquire an appropriate API.

With regard to the above problem, a large number of researchers in the field of service computing have conducted studies on a service recommendation technology. For example, Jiang et al. embedded an API entity in a service knowledge graph into low-dimensional space through representation learning, and then computed a distance between API vectors to recommend a relevant API. Yao et al. studied the problem of API recommendation based on a regularized matrix factorization framework, factorized an API-Mashup matrix into two low-dimensional matrices, and proposed a latent variable model to capture implicit correlations between APIs. However, the above methods fail to learn deep features of the service and struggle to capture high-order feature interaction of the Web API, resulting in slightly low accuracy in service recommendation.

A graph neural network, a type of neural network processing graph-structured data, is characterized in that data are represented as nodes, relations between the data are represented as edges, and features and information of the data are mined by transmitting and aggregating information and topological structures between nodes, and has been widely applied in molecular structures, recommendation systems, and social networks. For example, Liu et al. represented user session information through a gated neural network, and aggregated information about users and their friends in a social network in a graph attention network, thereby effectively modeling user preferences. Gu et al. proposed a method for factorizing a matrix based on random walk, which enabled nodes to characterize a topological structure of a graph by embedding autocovariance similarity, and mined dissimilarity distribution in the graph through a specific aggregation function, thereby acquiring latent correlations between users and items. Some researchers in the field of service computing have applied the graph neural network to improve accuracy of service recommendation. For example, Ling et al. captured a high-order collaborative signal and project structure information in an API call through the graph neural network, and integrated textual attributes of nodes in the neural network to represent semantics, which improved accuracy of API recommendation to some extent. Kang et al. proposed a method for recommending a service through a graph neural network and an autoencoder technology, which considered both local and global structural relations in a Web API collaboration network as well as network structural relations of message passing to recommend a Web service matching user query. Although the above recommendation methods have improved accuracy of recommendation to some extent, they do not consider differences in complex signals during user-API service interaction, fail to accurately capture the function of different signals in API service mining, and ignore the problem of changes in user requirements, resulting in a lack of research on personalized service recommendation requirements.

### SUMMARY

In order to overcome the defects of the prior art, the present disclosure provides a method for recommending a Web service based on a graph attention convolutional network and graph pooling. The method includes: constructing a service network graph based on a dual-tower model, and differentiating a focus service from the service network graph; providing a dual-level aware self-attention mechanism in a graph convolution process, controlling an amount of information aggregated from a source node to a target node in a cluster-aware self-attention mechanism, and controlling an amount of information received by the target node from the source node in a query-aware self-attention mechanism; then, further extracting service information according to a graph pooling method taking a heterogeneous node coarsening strategy as a core; and splicing a dynamic representation, a graph-level representation, and a target service of the focus service, learning a composite embedding representation, and predicting a probability of interaction between the target service and a user at a next moment in a prediction layer.

The technical solution used by the present disclosure to solve the technical problem of the present disclosure is as follows:
a method for recommending a Web service based on a graph attention convolutional network and graph pooling includes:
step 1, creating a service data set, acquiring service interaction data, and constructing a service network graph according to a dual-tower model;
step 2, for a graph structure in the service network graph, designing a dual-level aware self-attention mechanism to aggregate service embedding vectors, and extracting service features according to the graph convolutional network;
step 3, further extracting important service information according to the graph pooling taking heterogeneous node graph coarsening as a core, where heterogeneous nodes refer to nodes of various types existing in the service network graph; and
step 4, capturing a dynamically changing focus service, and performing graph-level representation readout, and obtaining a final output embedding according to a focus service representation and the graph-level representation readout, so as to obtain a probability of interaction between a target service and the user.

Further, step 1 includes:
step (1.1) using the dual-tower model that is a deep learning framework, a basic concept of which two different data features are learnt from two towers respectively and then similarity between two pieces of input data is measured;
step (1.2) creating the service data set, crawling user information and an application programming interface (API) service from a related website, and analyzing and sorting a collected result to obtain the service data set, where the service data set includes the following information:
step (1.2.1) a user: a developer calling the API service, which is represented by a symbol uᵢ; and
step (1.2.2) the API service: an interface that allows communication and data exchange between different software applications, which is a recommended object in service recommendation and is represented by a symbol aᵢ;
step (1.3) constructing an interaction sequence set, and acquiring interaction information between the user and the service on a time stamp from the service data set to form an interaction sequence, where a process includes:
step (1.3.1) constructing the interaction sequence, which is represented by a symbol seq; and
step (1.3.2) traversing the service data set, and putting the service aᵢ into seq under the condition that an interaction behavior exists between the user uⱼ and the service aᵢ;
step (1.4) sorting interaction sequences according to time stamps to form the interaction sequence set, where a process includes:
step (1.4.1) constructing the interaction sequence set, which is represented by a symbol S; and
step (1.4.2) arranging all the interaction sequences according to a time sequence to obtain the interaction sequence set; and
step (1.5) constructing the service network graph, and converting the interaction sequence set into the service network graph through the dual-tower model.

Preferably, in step (1.5), a process of constructing the service network graph includes:
step (1.5.1) defining the service network graph, which is represented by a symbol G, where a node set of G is represented by a symbol V, an edge set of G is represented by E, and an adjacency matrix is represented by A′;
step (1.5.2) converting aᵢ in step (1.3.2) into a node vᵢ; and
step (1.5.3) inputting API service nodes into the dual-tower model for feature learning, computing similarity between services according to multi-head weighted cosine similarity, and then constructing the service network graph based on the similarity.

Step (1.5.3) includes:
step (1.5.3.1) converting any two API service nodes into embedding vectors hᵢ and hⱼ through one-hot encoding, where the one-hot encoding is an encoding method for converting classification variables into a numerical format;
step (1.5.3.2) encoding a description document and tag information of the API service in the interaction sequence;
step (1.5.3.3) fusing the API service embedding vectors and semantic vectors to obtain a service vector \tilde{h}ᵢ including semantic information, where a process is represented by a formula \tilde{h}ᵢ= [symbol] _{fusion}(hᵢ, sᵢ|θᵢ, ωᵢ), where a symbol [symbol] _{fusion}(⋅) represents a fusion function, the fusion function combines two features into a single representation according to a weighted sum method, and symbols θᵢ and ωᵢ are fusion function parameters;
step (1.5.3.4) measuring similarity between the two embedding vectors according to weighted cosine similarity, and assigning a result to sim_{i,j}, where a process is represented by a formula sim_{i,j}=cos(w⊙\tilde{h}ᵢ, w⊙\tilde{h}ⱼ), where a symbol cos(⋅) represents use of a cosine similarity measurement method, a symbol w represents a learnable weight vector, a symbol ⊙ represents a Hadamard product, the weighted cosine similarity is a method for measuring similarity between two vectors, and a concept of a weight is added into the weighed cosine similarity based on cosine similarity, so as to better reflect importance of different features;
step (1.5.3.5) extending a weighted cosine metric function to multi-head weighted cosine similarity metric by repeating ψ, computing ψ independent similarity matrices according to the similarity metric function, then taking an average value as final similarity of the two embedding vectors, and assigning a result to sim*_{i,j}, where a process is represented by formulas

$${sim}_{i , j}^{δ} = cos ( {w}_{δ} ⊙ {\tilde{h}}_{i} , {w}_{δ} ⊙ {\tilde{h}}_{j} ) and {sim}_{i , j}^{*} = \frac{1}{δ} {\sum }_{δ = 1}^{ψ} {sim}_{i , j}^{δ} ,$$

where a symbol

$${sim}_{i , j}^{δ}$$

represents similarity of a δ-th similarity matrix, a symbol w_{δ} represents a learnable weight vector of the δ-th similarity matrix, a symbol ψ represents the total number of heads of multi-head extension, each head captures different semantic information, and the multi-head weighted cosine similarity metric refers to computing weighted cosine similarity between vectors in multiple different dimensions;
step (1.5.3.6) connecting an edge between two API service nodes vᵢ and vⱼ having similarity in step (1.5.3.5), representing the edge by a symbol (vᵢ, e_{i,j}, vⱼ), so as to construct an initial service network graph G′, setting an element A′ᵥ_{ᵢ}_{,v}_{ⱼ} of the adjacency matrix A′ as 1, and setting A′ᵥ_{_{m*}}_{,v}_{_{n*}} in the adjacency matrix as 0 for two API service nodes v_{m*} and v_{n*} having no edge connection; and
step (1.5.3.7) performing sparsification on G′ through ε-sparsity to ensure subsequent graph convolution in a most relevant aspect of a graph, and then constructing a service network graph G after sparsification.

More preferably, step (1.5.3.2) includes:
step (1.5.3.2.1) using the description document of the API service that is a document for recording a function, a characteristic and interface information of the service;
step (1.5.3.2.2) using a service tag that is a short text for identifying a type of a service function;
step (1.5.3.2.3) performing word segmentation and stop word removal on description documents and tag information of any two API services; and
step (1.5.3.2.4) encoding the description documents and the tag information of the processed two API services to obtain semantic vectors Sᵢ and Sⱼ according to a bidirectional encoder representations from transformers (BERT) model; and
step (1.5.3.7) includes:
step (1.5.3.7.1) using ε-sparsity belonging to a model compression technology that improves operation efficiency of the model by making the adjacency matrix A′ sparse by discarding elements less than a threshold ε; and
step (1.5.3.7.2) extracting a symmetric sparse non-negative adjacency matrix from sim*_{i,j} of step (1.5.3.5), and assigning a result to A, where a process is represented by a formula

$${A}_{i , j} = \{ \begin{matrix}1 , & {sim}_{i , j}^{*} >= {Rank}_{ε {n}^{2}} ( {sim}^{*} ) \\ 0 , & other cases\end{matrix} ,$$

where a symbol A_{i,j} represents an element in an i-th row and a j-th column in A, a symbol Rank_{εn}_{²}(sim*) represents a εn²-th largest value in ranking of a return similarity matrix sim*, a symbol n represents the number of service nodes, a symbol n² is a square operation, and a symbol ε controls overall sparsity of G.

Furthermore, step 2 includes:
step (2.1) designing the dual-level aware self-attention mechanism in the graph convolutional network; and
step (2.2) adjusting a weight of a service embedding vector in an information aggregation according to the dual-level aware self-attention mechanism, and updating an embedding representation through a graph convolution operation.

Preferably, a process of designing the dual-level aware self-attention mechanism of step (2.1) includes:
step (2.1.1) using the dual-level aware self-attention mechanism including a cluster-aware self-attention mechanism and a query-aware self-attention mechanism;
step (2.1.2) designing the cluster-aware self-attention mechanism, where a process includes:
step (2.1.2.1) assuming that a cluster is formed by taking a target node vᵢ as an expected median, and k** hop neighbors of the target node are taken as an acceptance domain of the cluster, acquiring a normalized activity degree of the target node vᵢ, and assigning a result to

$${r}_{i}^{*} ,$$

where a process is represented by a formula

$${r}_{i}^{*} = \frac{log ( \vert {𝒩}_{{v}_{i}} \vert )}{\frac{1}{\vert {V}^{*} \vert} {\sum }_{{v}_{{j}^{*}} ∈ {V}^{*}} log ( \vert {𝒩}_{{v}_{{j}^{*}}} \vert )} ,$$

where a symbol |V*| represents the total number of first-order neighbors of all nodes, a symbol [symbol] represents a set of first-order neighbors of the node vᵢ, a symbol v_{j*} represents other nodes apart from the node vᵢ, the expected median is a pre-assumed central value in each cluster, an activity degree of the nodes refers to a frequency of interaction between the nodes and the user, and normalization is a data processing technology and aims to convert data having different features into a unified standard for subsequent analysis and processing; and
step (2.1.2.2) acquiring a central point of each cluster according to a k-medoids algorithm, where a process includes:
step (2.1.2.2.1) randomly selecting k** node embeddings from an API service embedding as an initial cluster center, where the k-medoids algorithm is a common cluster analysis method;
step (2.1.2.2.2) computing an Euclidean distance from each API service node embedding vector

$${\tilde{h}}_{j}^{l}$$

to the central point

$${\tilde{h}}_{{i}_{c}}^{l}$$

of each cluster, and assigning a result to

$$d ( {\tilde{h}}_{j}^{l} , {\tilde{h}}_{{i}_{c}}^{l} ) ,$$

where a process is represented by a formula

$$d ( {\tilde{h}}_{j}^{l} , {\tilde{h}}_{{i}_{c}}^{l} ) = \sqrt{{\sum }_{j = 1}^{n} {( {\tilde{h}}_{j}^{l} , {\tilde{h}}_{{i}_{c}}^{l} )}^{2}} ,$$

where a symbol i_{c} represents that a node is the central point of the cluster, and a symbol n represents the total number of API service node embeddings;
step (2.1.2.2.3) assigning each API service node to a cluster nearest to the API service node according to

$$d ( {\tilde{h}}_{j}^{l} , {\tilde{h}}_{{i}_{c}}^{l} )$$

of step (2.1.2.2.2);
step (2.1.2.2.4) computing an overall deviation, and assigning a result to S*, where a process is represented by a formula

$$S *= {\sum }_{k = 1}^{{K}^{′}} {\sum }_{{\tilde{h}}_{j}^{l} ∈ {C}_{{i}_{c}}} d ( {\tilde{h}}_{j}^{l} , {\tilde{h}}_{{i}_{c}}^{l} ) ,$$

where a symbol K′ represents the total number of the clusters, and a symbol Cᵢ_{_{c}} represents a node embedding set of an i_{c}-th cluster;
step (2.1.2.2.5) repeating steps (2.1.2.2.1)-(2.1.2.2.4) until S* in step (2.1.2.2.4) is no longer changed; and
step (2.1.2.2.6) computing an API service cluster-aware self-attention weight, where a normalized user activity degree participates in computation in a non-destructive way, and assigning a result to aᵢ, where a process is represented by a formula

$${α}_{i} = softmax ( \frac{{W}_{{q}^{**}}^{″} {{\tilde{h}}_{{i}_{c}}^{l} ( {W}_{k}^{″} {\tilde{h}}_{{i}_{c}}^{l} )}^{⊤}}{\sqrt{d}} ) \cdot {r}_{i}^{*} {W}_{v}^{″} {\tilde{h}}_{i}^{l} ,$$

where symbols W″_{q**}, W″ₖ, and W″ᵥ represent learnable weight matrices,

$${( {W}_{k}^{″} {\tilde{h}}_{{i}_{c}}^{l} )}^{⊤}$$

represents a transposition of

$${W}_{k}^{″} {\tilde{h}}_{{i}_{c}}^{l} ,$$

\sqrt{d} is a scaling factor and prevents a result of an inner product from being excessively large, softmax is an activation function, the non-destructive way refers to only serving as an influence coefficient of

$${W}_{v}^{″} {\tilde{h}}_{i}^{l}$$

without influencing

$${W}_{{q}^{**}}^{″} {\tilde{h}}_{{i}_{c}}^{l} and {W}_{k}^{″} {\tilde{h}}_{{i}_{c}}^{l} ,$$

and more efficient modeling is achieved by controlling an information source of a self-attention component; and
step (2.1.3) designing the query-aware self-attention mechanism, where a process of designing the query-aware self-attention mechanism includes:
step (2.1.3.1) representing an API service embedding vector queried by the user for an i′-th time by a symbol h^{q′}^{_{i′}}, where a superscript q′_{i′} represents that a current service vector is a query vector of the user;
step (2.1.3.2) representing user query service embedding representations sorted according to time by a symbol Q={h^{q′}^{₁}, h^{q′}^{₂}, . . . , h^{q′}^{_{t*}}}, where t* represents a length of time;
step (2.1.3.3) computing attention scores of Q at different times, and assigning a result to ϑⱼ, where a process is represented by a formula

$$\text{?} = Attention ( \frac{{W}_{q} {h}^{{q}_{j}^{′}} \cdot {( {W}_{k} {h}^{{q}_{j}^{′}} )}^{⊤}}{\sqrt{{d}^{′}}} ) ,$$

where symbols W_{q} and Wₖ are trainable time parameters, (Wₖh^{q′}^{ⱼ})^{T} represents a transposition of Wₖh^{q′}^{ⱼ}, a symbol d′ represents a query representation dimension, \sqrt{ } is a root operation, and Attention is a double-layer feedforward neural network by taking a leaky rectified linear unit (LeakyReLU) as an activation function; and
step (2.1.3.4) computing an attention weight in an API service node aggregation in a non-destructive way, and assigning a result to βⱼ, where a process is represented by a formula

$${β}_{j} = softmax ( \frac{\text{?} {W}_{q}^{′} * {\tilde{h}}_{j}^{l} \cdot {( \text{?} {W}_{k}^{′} {\tilde{h}}_{j}^{l} )}^{⊤}}{\sqrt{d}} ) \cdot {W}_{v}^{′} {\tilde{h}}_{t}^{l} ,$$

where symbols

$${W}_{q}^{′} * , {W}_{k}^{′} and {W}_{v}^{′}$$

represent learnable weight matrices, \sqrt{d} is a scaling factor and prevents a result of an inner product from being excessively large,

$${\tilde{h}}_{j}^{l}$$

represents a source node,

$${\tilde{h}}_{t}^{l}$$

represents the target node, softmax is an activation function, the non-destructive way refers to only serving as influence coefficients of

$${W}_{q}^{′} * {\tilde{h}}_{j}^{l} and {W}_{k}^{′} {\tilde{h}}_{j}^{l}$$

without influencing

$${W}_{v}^{′} {\tilde{h}}_{t}^{l} ,$$

and more effective modeling is achieved by controlling the information source of the self-attention component.

A process of embedding updating of step (2.2) includes:
step (2.2.1) computing an attention weight when the service node embedding is updated according to the dual-level aware self-attention mechanism, and assigning a result to Eᵢⱼ, where a process is represented by a formula Eᵢⱼ=λαᵢ+ (1−λ)βⱼ, where a symbol λ represents a balance coefficient that balances a ratio between αᵢ and βⱼ;
step (2.2.2) inputting an API service node embedding matrix

$$\{ {\tilde{h}}_{1}^{l} , {\tilde{h}}_{2}^{l} , … , {\tilde{h}}_{n}^{l} \} , {\tilde{h}}_{i}^{l} ∈ {ℝ}^{d}$$

into an l+1-th layer, where a symbol n represents the number of node embeddings, ∈ is a mathematical symbol, and represents a belonging relation, [symbol] ^{d} represents a set including d-dimensional real vectors, and d is an embedding size of the nodes; and
step (2.2.3) computing a service embedding representation of the l+1-th layer, and assigning a result to

$${\tilde{h}}_{i}^{l + 1} ,$$

where a process is represented by a formula

$${\tilde{h}}_{i}^{l + 1} = {\tilde{h}}_{i}^{l} + {\sum }_{{v}_{k} ∈ {ℳ}_{i}} \frac{1}{\vert {ℳ}_{i} \vert} {E}_{ij} {\tilde{h}}_{k}^{l} ,$$

where a symbol [symbol] represents a set of neighbor nodes of a node vᵢ, Σ is a summation symbol, and vₖ represents a neighbor node of vᵢ.

Furthermore, step 3 includes:
step (3.1) acquiring a heterogeneous API service node embedding matrix, where a process includes:
step (3.1.1) dividing the node embedding matrix into F submatrices according to types of the API service nodes, where a node embedding matrix of an i′-th type is represented as

$${Y}_{{i}^{′}}^{L} = \{ {\tilde{h}}_{1}^{L} , {\tilde{h}}_{2}^{L} , … , {\tilde{h}}_{{n}^{′}}^{L} \} ,$$

where a symbol n represents the total number of node embeddings of the type;
step (3.1.2) learning the node embeddings of each type in a graph pooling layer, and assigning a result to

$${T}_{{i}^{′}}^{L} ,$$

where a process is represented by a formula

$${T}_{{i}^{′}}^{L} = Pool GNN ( {Y}_{{i}^{′}}^{L} ; {Θ}_{{i}^{′}}^{L} ) ,$$

where a symbol

$${T}_{{i}^{′}}^{L}$$

represents a pooling matrix or an i′-th node type, a symbol

$${Θ}_{{i}^{′}}^{L}$$

represents a parameter set of a pooled graph neural network (GNN), and a symbol PoolGNN(⋅) represents that a graph pooling operation is currently performed;
step (3.1.3) compressing

$${T}_{{i}^{′}}^{L}$$

in step (3.1.2) to obtain a summary matrix, and assigning a result to

$${Ag}_{{i}^{′}}^{L} ,$$

where a process is represented by a formula

$${Ag}_{{i}^{′}}^{L} = softmax ( {W}_{{i}^{′}}^{L} {T}_{{i}^{′}}^{L} + {B}_{{i}^{′}}^{L} ) ,$$

where symbols

$${W}_{{i}^{′}}^{L} and {B}_{{i}^{′}}^{L}$$

are learnable parameters, and softmax(⋅) is an activation function;
step (3.1.4) obtaining an aligned service node embedding pooling matrix

$${P}_{{i}^{′}}^{L} from {Ag}_{{i}^{′}}^{L}$$

according to a zero-padding technology, where the zero-padding technology refers to adding a zero element at an edge of data to maintain stability of an embedding dimension of the summary matrix; and
step (3.1.5) providing a node embedding aggregator to perform node embedding aggregation, and assigning a result to

$${Y}_{{i}^{′}}^{L + 1} ,$$

where a process is represented by a formula

$${Y}_{{i}^{′}}^{L + 1} = {P}_{{i}^{′}}^{{L}^{T}} {Y}_{{i}^{′}}^{L} ,$$

and then, splicing node embedding matrices of various types to obtain a complete node embedding matrix

$${Y}^{L + 1} = concat ( {Y}_{1}^{L + 1} , {Y}_{2}^{L + 1} , … , {Y}_{F}^{L + 1} ) = \{ {\tilde{h}}_{1}^{L + 1} , {\tilde{h}}_{2}^{L + 1} , … , {\tilde{h}}_{N}^{L + 1} \} ,$$

where a symbol concat(⋅) represents that a splicing operation is currently performed, a symbol

$${P}_{{i}^{′}}^{{L}^{T}}$$

represents a transposition of

$${P}_{{i}^{′}}^{L}$$

in step (3.1.4), a subscript N represents the total number of node embedding matrix embeddings after pooling, and a superscript L+1 represents that the current node embedding matrix is a matrix through heterogeneous pooling;
step (3.2) coarsening the graph according to global graph content (2GCont) and a cross-attention mechanism (CAMe), where a process of graph coarsening includes:
step (3.2.1) computing a global graph content matrix, and assigning a result to C, where a process is represented by a formula

$$C = \{ {\tilde{h}}_{1}^{L + 1} , {\tilde{h}}_{2}^{L + 1} , … , {\tilde{h}}_{N}^{L + 1} \} X ,$$

where a symbol X represents a parameterized weight matrix;
step (3.2.2) computing the CAMe, and assigning a result to M, where a process is represented by a formula Mᵢⱼ=LeakyReLU(a^{T} [C_{(i,⋅)}∥C_{(⋅,j)}]), where a symbol a^{T} represents a trainable shared attention parameter, a symbol C_{(i,⋅)}∈ [symbol] ^{N} represents a service node embedding having a dimension of N before coarsening, C_{(⋅,j)}∈ [symbol] ^{N′} represents a service cluster embedding having a dimension of N′ after coarsening, and [⋅∥⋅] represents a splicing operation; and
step (3.2.3) normalizing Mᵢⱼ, and assigning a result to M, where a process is represented by a formula

$$M = \frac{exp ( {M}_{ij} )}{{\sum }_{g ∈ {N}^{′}} exp ( {M}_{i g} )} ,$$

where a symbol exp is a natural exponent operation, a symbol M_{ig} represents all elements in an i-th row, and a symbol N′ represents the number of columns in an i-th row of M;
step (3.3) generating a service cluster embedding of a coarsened graph according to the service node embedding matrix

$$\{ {\tilde{h}}_{1}^{L} , {\tilde{h}}_{2}^{L} , … , {\tilde{h}}_{n}^{L} \}$$

before pooling, and assigning a result to

$${\tilde{h}}_{{i}^{*}}^{*} ,$$

where a process is represented by a formula

$$\{ {\tilde{h}}_{1}^{*} , {\tilde{h}}_{2}^{*} , … , {\tilde{h}}_{m}^{*} \} = {M}^{T} \{ {\tilde{h}}_{1}^{L} , {\tilde{h}}_{2}^{L} , … , {\tilde{h}}_{n}^{L} \} ,$$

where a symbol L represents the number of layers of final graph convolution, a symbol m represents the number of service cluster embeddings, and a symbol M^{T} represents a transposition of the CAMe M in step (3.2.2); and
step (3.4) generating service cluster scores of the coarsened graph according to service node scores {γ₁, γ₂, . . . , γₙ} before coarsening, and assigning a result to

$${λ}_{{i}^{′}}^{*}$$

where a process is represented by a formula

$$\{ {λ}_{1}^{*} , {λ}_{2}^{*} , … , {λ}_{m}^{*} \} = {M}^{T} \{ {γ}_{1} , {γ}_{2} , … , {γ}_{n} \} ,$$

where a symbol M^{T} represents a transposition of the CAMe M in step (3.2.2), and a symbol γᵢ is an importance score of a service node vᵢ obtained by applying softmax to [symbol] in step (2.1.3.3).

Step 4 includes:
step (4.1) using a focus service that is a service densely connected in the service network graph and represents a main requirement of the user;
step (4.2) capturing the dynamically changing focus service of the user under a multi-head self-attention mechanism, where a process includes:
step (4.3) computing an average node embedding of all service nodes according to an average function after forward computation of a propagation layer, generating a graph-level representation of the service network graph G before pooling, and assigning a result to \tilde{h}_{G}, where a process is represented by a formula

$${\tilde{h}}_{G} = Mean ( {γ}_{{i}^{*}} {\tilde{h}}_{i}^{L} , i ∈ G ) ,$$

where a symbol Mean represents the average function; and
step (4.4) predicting a probability of interaction between the user and the target service, and making a recommendation.

Preferably, step (4.2) includes:
step (4.2.1) using the multi-head self-attention mechanism that is a variant of a self-attention mechanism and is capable of extracting information from different subspaces at different positions;
step (4.2.2) representing a cluster embedding matrix obtained in step (3.3) by a symbol H, i.e.

$$H = \{ {h}_{1}^{*} , {\tilde{h}}_{2}^{*} , … , {\tilde{h}}_{m}^{*} \} ,$$

where a symbol

$${\tilde{h}}_{{i}^{*}}^{*}$$

represents an i*-th service cluster embedding; and
step (4.2.3) capturing the dynamically changing focus service, and assigning a result to \tilde{h}_{Z}, where a process is represented by a formula \tilde{h}_{Z}=(head₁∥head₂∥ . . . ∥head_{h*})W^{O}, where a symbol h* represents the total number of heads of multiple heads, a symbol ∥ represents a splicing operation, a symbol head_{i**} represents an embedding representation learned from an i**-th head, a process of embedding representation learning is represented by a formula head_{i**}=ATTENTION(HW^{Q}*, HW^{K}*, HW^{V}*), symbols W^{O}, W^{Q}*, W^{K}*, and W^{V}* are learnable parameters, and the attention mechanism ATTENTION(⋅) is achieved through a scaling dot product and a softmax function.

More preferably, step (4.4) includes:
step (4.4.1) splicing \tilde{h}_{Z}, \tilde{h}_{G}, and a target service embedding \tilde{h}ₜ to obtain a composite embedding vector, then learning a composite embedding representation through a fully connected layer to obtain a probability of interaction between the user and the API service, and assigning a result to \hat{r}, where a process is represented by a formula \hat{r}=Predict(\tilde{h}_{Z}∥\tilde{h}_{G}∥\tilde{h}ₜ∥\tilde{h}_{Z}⊙\tilde{h}ₜ∥\tilde{h}_{G}⊙\tilde{h}ₜ), where ∥ is a splicing symbol, a symbol ⊙ is a Hadamard product, and Predict(⋅) represents a prediction function having a two-layer feedforward neural network; and
step (4.4.2) constructing a Bayesian loss function training model, and assigning a loss function result to [symbol] _{BPR}, where a process is represented by a formula

$${ℒ}_{BPR} = {\sum }_{{i}^{*} ∈ {S}_{{u}_{i}} , {j}^{*} ∉ {S}_{{u}_{i}}} - log σ ( {\hat{r}}_{{i}^{*}} - {\hat{r}}_{{j}^{*}} ) + η {‖ Θ ‖}_{2}^{2} ,$$

where a symbol Sᵤ_{ᵢ} represents the interaction sequence set of the user uᵢ, a symbol \hat{r}_{i*} represents a positive sample, and represents that the user interacts with the service, \hat{r}_{j*} represents that the user does not interact with the service, a symbol log represents a logarithmic operation, a symbol σ(⋅) represents a sigmoid function, and a symbol

$$η {‖ Θ ‖}_{2}^{2}$$

represents an L₂ regularizer parameterized by η, and has a function of preventing a problem of overfitting in a model learning process. The Bayesian loss function is a function that measures a difference between a predicted result and an actual result.

### BRIEF DESCRIPTION OF THE DRAWINGS

FIGURE is a flowchart of a method for recommending a Web service based on a graph attention convolutional network and graph pooling.

### DETAILED DESCRIPTIONS OF THE EMBODIMENTS

The present disclosure will be further described below in combination with the accompanying drawings.

With reference to FIGURE, a method for recommending a Web service based on a graph attention convolutional network and graph pooling includes:
step 1, a service data set is created, service interaction data is acquired, and a service network graph is constructed according to a dual-tower model. A process includes:

Step (1.1) the dual-tower model that is a deep learning framework, a basic concept of which two different data features are learnt from two towers respectively and then similarity between two pieces of input data is measured is used.

Step (1.2) the service data set is created, user information and an application programming interface (API) service are crawled from a related website, and a collected result is analyzed and sorted to obtain the service data set.

In step (1.2), the service data set includes the following information:
step (1.2.1) a user: a developer calling the API service, which is represented by a symbol uᵢ; and
step (1.2.2) the API service: an interface that allows communication and data exchange between different software applications, which is a recommended object in service recommendation and is represented by a symbol aᵢ.

Step (1.3) an interaction sequence set is constructed, and interaction information between the user and the service on a time stamp is acquired from the service data set to form an interaction sequence.

A process of step (1.3) includes:
step (1.3.1) the interaction sequence is constructed, which is represented by a symbol seq; and
step (1.3.2) the service data set is traversed, and the service aᵢ is put into seq under the condition that an interaction behavior exists between the user uⱼ and the service aᵢ.

Step (1.4) interaction sequences are sorted according to time stamps to form the interaction sequence set.

A process of step (1.4) includes:
step (1.4.1) the interaction sequence set is constructed, which is represented by a symbol S; and
step (1.4.2) all the interaction sequences are arranged according to a time sequence to obtain the interaction sequence set.

Step (1.5) the service network graph is constructed, and the interaction sequence set is converted into the service network graph through the dual-tower model.

In step (1.5), a process of constructing the service network graph includes:
step (1.5.1) the service network graph is defined, which is represented by a symbol G, where a node set of G is represented by a symbol V, an edge set of G is represented by E, and an adjacency matrix is represented by A′;
step (1.5.2) aᵢ in step (1.3.2) is converted into a node vᵢ; and
step (1.5.3) API service nodes are input into the dual-tower model for feature learning, similarity between services is computed according to multi-head weighted cosine similarity, and then the service network graph is constructed based on the similarity.

Step (1.5.3) includes:
step (1.5.3.1) any two API service nodes are converted into embedding vectors hᵢ and hⱼ through one-hot encoding, where the one-hot encoding is an encoding method for converting classification variables into a numerical format; and
step (1.5.3.2) a description document and tag information of the API service in the interaction sequence are encoded.

Further, a process of step (1.5.3.2) includes:
step (1.5.3.2.1) the description document of the API service that is a document for recording a function, a characteristic and interface information of the service is used;
step (1.5.3.2.2) a service tag that is a short text for identifying a type of a service function is used;
step (1.5.3.2.3) word segmentation and stop word removal are performed on description documents and tag information of any two API services; and
step (1.5.3.2.4) the description documents and the tag information of the processed two API services tare encoded o obtain semantic vectors sᵢ and sⱼ according to a bidirectional encoder representations from transformers (BERT) model, where the BERT model is a natural language processing model.

Step (1.5.3.3) the API service embedding vectors and semantic vectors are fused to obtain a service vector \tilde{h}ᵢ including semantic information. A process is represented by a formula \tilde{h}ᵢ= [symbol] _{fusion}(hᵢ, sᵢ|θᵢ, ωᵢ). A symbol [symbol] _{fusion}(⋅) represents a fusion function, the fusion function combines two features into a single representation according to a weighted sum method, and symbols θᵢ and ωᵢ are fusion function parameters.

Step (1.5.3.4) similarity between the two embedding vectors is measured according to weighted cosine similarity, and a result is assigned to sim_{i,j}. A process is represented by a formula sim_{i,j}=cos(w⊙\tilde{h}ᵢ, w⊙\tilde{h}ⱼ). A symbol cos(⋅) represents use of a cosine similarity measurement method, a symbol w represents a learnable weight vector, a symbol ⊙ represents a Hadamard product, the weighted cosine similarity is a method for measuring similarity between two vectors, and a concept of a weight is added into the weighed cosine similarity based on cosine similarity, so as to better reflect importance of different features.

Step (1.5.3.5) a weighted cosine metric function is extended to multi-head weighted cosine similarity metric by repeating ψ, ψ independent similarity matrices are computed according to the similarity metric function, then an average value is taken as final similarity of the two embedding vectors, and a result is assigned to

$${sim}_{i , j}^{*} .$$

A process is represented by formulas

$${sim}_{i , j}^{δ} = cos ( {w}_{δ} ⊙ {\tilde{h}}_{i} , {w}_{δ} ⊙ {\tilde{h}}_{j} ) and {sim}_{i , j}^{*} = \frac{1}{δ} {\sum }_{δ = 1}^{ψ} {sim}_{i , j}^{δ} .$$

A symbol

$${sim}_{i , j}^{δ}$$

represents similarity of a δ-th similarity matrix, a symbol w_{δ} represents a learnable weight vector of the δ-th similarity matrix, a symbol ψ represents the total number of heads of multi-head extension, each head captures different semantic information, and the multi-head weighted cosine similarity metric refers to computing weighted cosine similarity between vectors in multiple different dimensions.

Step (1.5.3.6) an edge is connected between two API service nodes vᵢ and vⱼ having similarity in step (1.5.3.5), the edge is represented by a symbol (vᵢ, e_{i,j}, vⱼ), so as to construct an initial service network graph G′, an element A′ᵥ_{ᵢ}_{,v}_{ⱼ} of the adjacency matrix A′ is set as 1, and

$${A}_{{v}_{{m}^{*}} , {v}_{{n}^{*}}}^{′}$$

in the adjacency matrix is set as 0 for two API service nodes vₘ* and vₙ* having no edge connection.
step (1.5.3.7) sparsification is performed on G′ through ε-sparsity to ensure subsequent graph convolution in a most relevant aspect of a graph, and then a service network graph G after sparsification is constructed.

Step (1.5.3.7) includes:
step (1.5.3.7.1) ε-sparsity belonging to a model compression technology that improves operation efficiency of the model by making the adjacency matrix A′ sparse by discarding elements less than a threshold ε is used; and
step (1.5.3.7.2) a symmetric sparse non-negative adjacency matrix is extracted from

$${sim}_{i , j}^{*}$$

of step (1.5.3.5), and a result is assigned to A, where a process is represented by a formula

$${A}_{i , j} = \{ \begin{matrix}1 , & {sim}_{i , j}^{*} >= {Rank}_{ε {n}^{2}} ( {sim}^{*} ) \\ 0 , & other cases\end{matrix} ,$$

where a symbol A_{i,j} represents an element in an i-th row and a j-th column in A, a symbol Rank_{εn}_{²}(sim*) represents a εn²-th largest value in ranking of a return similarity matrix sim*, a symbol n represents the number of service nodes, a symbol n² is a square operation, and a symbol ε controls overall sparsity of G.

Step 2, for a graph structure in the service network graph, a dual-level aware self-attention mechanism is designed to aggregate service embedding vectors, and service features are extracted according to the graph convolutional network. A process is as follows:
step (2.1) the dual-level aware self-attention mechanism is designed in the graph convolutional network. A design process includes:
step (2.1.1) the dual-level aware self-attention mechanism including a cluster-aware self-attention mechanism and a query-aware self-attention mechanism is used;
step (2.1.2) the cluster-aware self-attention mechanism is designed, where a process includes:
step (2.1.2.1) assuming that a cluster is formed by taking a target node vᵢ as an expected median, and k** hop neighbors of the target node are taken as an acceptance domain of the cluster, a normalized activity degree of the target node vᵢ is acquired, and a result is assigned to

$${r}_{i}^{*} ,$$

where a process is represented by a formula

$${r}_{i}^{*} = \frac{log ( \vert {𝒩}_{{v}_{i}} \vert )}{\frac{1}{\vert {V}^{*} \vert} {\sum }_{{v}_{{j}^{*}} ∈ {V}^{*}} log ( \vert {𝒩}_{{v}_{{j}^{*}}} \vert )} ,$$

where a symbol |V*| represents the total number of first-order neighbors of all nodes, a symbol [symbol] represents a set of first-order neighbors of the node vᵢ, a symbol v_{j*} represents other nodes apart from the node vᵢ, the expected median is a pre-assumed central value in each cluster, an activity degree of the nodes refers to a frequency of interaction between the nodes and the user, and normalization is a data processing technology and aims to convert data having different features into a unified standard for subsequent analysis and processing; and
step (2.1.2.2) a central point of each cluster is acquired according to a k-medoids algorithm, where a process includes:
step (2.1.2.2.1) k** node embeddings are randomly selected from an API service embedding as an initial cluster center, where the k-medoids algorithm is common cluster analysis method;
step (2.1.2.2.2) an Euclidean distance from each API service node embedding vector

$${\tilde{h}}_{j}^{l}$$

to the central point

$${\tilde{h}}_{{i}_{c}}^{l}$$

of each cluster is computed, and a result is assigned to

$$d ( {\tilde{h}}_{j}^{l} , {\tilde{h}}_{{i}_{c}}^{l} ) ,$$

where a process is represented by a formula

$$d ( {\tilde{h}}_{j}^{l} , {\tilde{h}}_{{i}_{c}}^{l} ) = \sqrt{{\sum }_{j = 1}^{n} {( {\tilde{h}}_{j}^{l} - {\tilde{h}}_{{i}_{c}}^{l} )}^{2}} ,$$

where a symbol i_{c} represents that a node is the central point of the cluster, and a symbol n represents the total number of API service node embeddings;
step (2.1.2.2.3) each API service node is assigned to a cluster nearest to the API service node according to

$$d ( {\tilde{h}}_{j}^{l} , {\tilde{h}}_{{i}_{c}}^{l} )$$

of step (2.1.2.2.2);
step (2.1.2.2.4) an overall deviation is computed, and a result is assigned to S*, where a process is represented by a formula

$${S}^{*} = {\sum }_{k = 1}^{K ′} {\sum }_{{\tilde{h}}_{j}^{l} ∈ {C}_{{i}_{c}}} d ( {\tilde{h}}_{j}^{l} , {\tilde{h}}_{{i}_{c}}^{l} ) ,$$

where a symbol K′ represents the total number of the clusters, and a symbol Cᵢ_{_{c}} represents a node embedding set of an i_{c}-th cluster;
step (2.1.2.2.5) steps (2.1.2.2.1)-(2.1.2.2.4) are repeated until S* in step (2.1.2.2.4) is no longer changed; and
step (2.1.2.2.6) an API service cluster-aware self-attention weight is computed, where a normalized user activity degree participates in computation in a non-destructive way, and a result is assigned to αᵢ, where a process is represented by a formula

$${α}_{i} = soft max ( \frac{{W}_{q}^{″} ** {\tilde{h}}_{{i}_{c}}^{l} \cdot {( {W}_{k}^{″} {\tilde{h}}_{{i}_{c}}^{l} )}^{T}}{\sqrt{d}} ) \cdot {r}_{i}^{*} {W}_{v}^{″} {\tilde{h}}_{i}^{l} ,$$

where symbols W″_{q**}, W″ₖ, and W″ᵥ represent learnable weight matrices,

$${( {W}_{k}^{″} {\tilde{h}}_{{i}_{c}}^{l} )}^{T}$$

represents a transposition of

$${W}_{k}^{″} {\tilde{h}}_{{i}_{c}}^{l} ,$$

\sqrt{d} is a scaling factor and prevents a result of an inner product from being excessively large, softmax is an activation function, the non-destructive way refers to only serving as an influence coefficient of

$${W}_{v}^{″} {\tilde{h}}_{i}^{l}$$

without influencing

$${W}_{{q}^{**}}^{″} {\tilde{h}}_{{i}_{c}}^{l} and {W}_{k}^{″} {\tilde{h}}_{{i}_{c}}^{l} ,$$

and more efficient modeling is achieved by controlling an information source of a self-attention component; and
step (2.1.3) the query-aware self-attention mechanism is designed, where a process includes:
step (2.1.3.1) an API service embedding vector queried by the user for an i′-th time is represented by a symbol h^{q′}^{_{i′}}, where a superscript q′_{i′} represents that a current service vector is a query vector of the user;
step (2.1.3.2) user query service embedding representations sorted according to time are represented by a symbol Q={h^{q′}^{₁}, h^{q′}^{₂}, . . . , h^{q′}^{_{t*}}}, where t* represents a length of time;
step (2.1.3.3) attention scores of Q at different times are computed, and a result is assigned to [symbol] , where a process is represented by a formula

$${ϑ}_{j} = Attention ( \frac{{W}_{q} {h}^{{q}_{j}^{′}} \cdot {( {W}_{k} {h}^{{q}_{j}^{′}} )}^{⊤}}{\sqrt{{d}^{′}}} ) ,$$

where symbols W_{q} and Wₖ are trainable time parameters, (Wₖh^{q′}^{ⱼ})^{T} represents a transposition of Wₖh^{q′}^{ⱼ}, a symbol d′ represents a query representation dimension, \sqrt{ } is a root operation, and Attention is a double-layer feedforward neural network by taking a leaky rectified linear unit (LeakyReLU) as an activation function; and
step (2.1.3.4) an attention weight in an API service node aggregation is computed in a non-destructive way, and a result is assigned to βⱼ, where a process is represented by a formula

$${β}_{j} = soft max ( \frac{{ϑ}_{j} {W}_{q}^{′} * {\tilde{h}}_{j}^{l} \cdot {( {ϑ}_{j} {W}_{k}^{′} {\tilde{h}}_{j}^{l} )}^{T}}{\sqrt{d}} ) \cdot {W}_{v}^{′} {\tilde{h}}_{t}^{l} ,$$

where symbols

$${W}_{q}^{′} * , {W}_{k}^{′} , and {W}_{v}^{′}$$

represent learnable weight matrices, \sqrt{d} is a scaling factor and prevents a result of an inner product from being excessively large,

$${\tilde{h}}_{j}^{l}$$

represents a source node,

$${\tilde{h}}_{t}^{l}$$

represents the target node, softmax is an activation function, the non-destructive way refers to only serving as influence coefficients of

$${W}_{q}^{′} * {\tilde{h}}_{j}^{l} and {W}_{k}^{′} {\tilde{h}}_{j}^{l}$$

without influencing

$${W}_{v}^{′} {\tilde{h}}_{t}^{l} ,$$

and more effective modeling is achieved by controlling the information source of the self-attention component.

Step (2.2) a weight of a service embedding vector in an information aggregation is adjusted according to the dual-level aware self-attention mechanism, and an embedding representation is updated through a graph convolution operation. A process of embedding updating includes:
step (2.2.1) an attention weight when the service node embedding is updated is computed according to the dual-level aware self-attention mechanism, and a result is assigned to Eᵢⱼ, where a process is represented by a formula Eᵢⱼ=λαᵢ+ (1−λ)βⱼ, where a symbol λ represents a balance coefficient that balances a ratio between αᵢ and βⱼ;
step (2.2.2) an API service node embedding matrix

$$\{ {\tilde{h}}_{1}^{l} , {\tilde{h}}_{2}^{l} , … , {\tilde{h}}_{n}^{l} \} , {\tilde{h}}_{i}^{l} ∈ {ℝ}^{d}$$

is input into an l+1-th layer, where a symbol n represents the number of node embeddings, ∈ is a mathematical symbol, and represents a belonging relation, [symbol] ^{d} represents a set including d-dimensional real vectors, and d is an embedding size of the nodes; and
step (2.2.3) a service embedding representation of the l+1-th layer is computed, and a result is assigned to

$${\tilde{h}}_{i}^{l + 1} ,$$

where a process is represented by a formula

$${\tilde{h}}_{i}^{l + 1} = {\tilde{h}}_{i}^{l} + {\sum }_{{v}_{k} ∈ {ℳ}_{i}} \frac{1}{\vert {ℳ}_{i} \vert} {E}_{ij} {\tilde{h}}_{k}^{l} ,$$

where a symbol [symbol] represents a set of neighbor nodes of a node vᵢ, Σ is a summation symbol, and vₖ represents a neighbor node of vᵢ.

Step 3, important service information is further extracted according to the graph pooling taking heterogeneous node graph coarsening as a core, where heterogeneous nodes refer to nodes of various types existing in the service network graph. A process includes:
step (3.1) a heterogeneous API service node embedding matrix is acquired.

A process of step (3.1) includes:
step (3.1.1) the node embedding matrix is divided into F submatrices according to types of the API service nodes, where a node embedding matrix of an i′-th type is represented as

$${Y}_{{i}^{′}}^{L} = \{ {\tilde{h}}_{1}^{L} , {\tilde{h}}_{2}^{L} , … , {\tilde{h}}_{{n}^{′}}^{L} \} ,$$

where a symbol n represents the total number of node embeddings of the type;
step (3.1.2) the node embeddings of each type is learnt in a graph pooling layer, and a result is assigned to

$${T}_{{i}^{′}}^{L} ,$$

where a process is represented by a formula

$${T}_{{i}^{′}}^{L} = PoolGNN ( {Y}_{{i}^{′}}^{L} ; {Θ}_{{i}^{′}}^{L} ) ,$$

where a symbol

$${T}_{{i}^{′}}^{L}$$

represents a pooling matrix of an i′-th node type, a symbol

$${Θ}_{{i}^{′}}^{L}$$

represents a parameter set of a pooled graph neural network (GNN), and a symbol PoolGNN (⋅) represents that a graph pooling operation is currently performed;
step (3.1.3)

$${T}_{{i}^{′}}^{L}$$

is compressed in step (3.1.2) to obtain a summary matrix, and a result is assigned to

$${Ag}_{{i}^{′}}^{L} ,$$

where a process is represented by a formula

$${Ag}_{{i}^{′}}^{L} = softmax ( {W}_{{i}^{′}}^{L} {T}_{{i}^{′}}^{L} + {B}_{{i}^{′}}^{L} ) ,$$

where symbols

$${W}_{{i}^{′}}^{L} and {B}_{{i}^{′}}^{L}$$

are learnable parameters, and softmax(⋅) is an activation function;
step (3.1.4) an aligned service node embedding pooling matrix

$${P}_{{i}^{′}}^{L}$$

is obtained from

$${Ag}_{{i}^{′}}^{L}$$

according to a zero-padding technology, where the zero-padding technology refers to adding a zero element at an edge of data to maintain stability of an embedding dimension of the summary matrix; and
step (3.1.5) a node embedding aggregator is provided to perform node embedding aggregation, and a result is assigned to

$${Y}_{{i}^{′}}^{L + 1} ,$$

where a process is represented by a formula

$${Y}_{{i}^{′}}^{L + 1} = {P}_{{i}^{′}}^{{L}^{T}} {Y}_{{i}^{′}}^{L} ,$$

and then, node embedding matrices of various types are spliced to obtain a complete node embedding matrix

$${Y}^{L + 1} = concat ( {Y}_{1}^{L + 1} , {Y}_{2}^{L + 1} , … , {Y}_{F}^{L + 1} ) = \{ {\tilde{h}}_{1}^{L + 1} , {\tilde{h}}_{2}^{L + 1} , … , {\tilde{h}}_{N}^{L + 1} \} ,$$

where a symbol concat(⋅) represents that a splicing operation is currently performed, a symbol

$${P}_{{i}^{′}}^{{L}^{T}}$$

represents a transposition of

$${P}_{{i}^{′}}^{L}$$

in step (3.1.4), a subscript N represents the total number of node embeddings after pooling, and a superscript L+1 represents that the current node embedding matrix is a matrix through heterogeneous pooling.

Step (3.2) the graph is coarsened according to global graph content (2GCont) and a cross-attention mechanism (CAMe). A process of graph coarsening includes:
step (3.2.1) a global graph content matrix is computed, and a result is assigned to C, where a process is represented by a formula

$$C = \{ {\tilde{h}}_{1}^{L + 1} , {\tilde{h}}_{2}^{L + 1} , … , {\tilde{h}}_{N}^{L + 1} \} X ,$$

where a symbol X represents a parameterized weight matrix;
step (3.2.2) the CAMe is computed, and a result is assigned to M, where a process is represented by a formula Mᵢⱼ=LeakyReLU(a^{T} [C_{(i,⋅)}∥C_{(⋅,j)}]), where a symbol a^{T} represents a trainable shared attention parameter, a symbol C_{(i,⋅)}∈ [symbol] ^{N} represents a service node embedding having a dimension of N before coarsening, C_{(⋅,j)}∈ [symbol] ^{N′} represents a service cluster embedding having a dimension of N′ after coarsening, and [⋅∥⋅] represents a splicing operation; and
step (3.2.3) Mᵢⱼ is normalized, and a result is assigned to M, where a process is represented by a formula

$$M = \frac{exp ( {M}_{ij} )}{{\sum }_{g ∈ {N}^{′}} exp ( {M}_{ig} )} ,$$

where a symbol exp is a natural exponent operation, a symbol M_{ig} represents all elements in an i-th row, and a symbol N′ represents the number of columns in an i-th row of M.

Step (3.3) a service cluster embedding of a coarsened graph is generated according to the service node embedding matrix

$$\{ {\tilde{h}}_{1}^{L} , {\tilde{h}}_{2}^{L} , … , {\tilde{h}}_{n}^{L} \}$$

before pooling, and a result is assigned to

$${\tilde{h}}_{{i}^{*}}^{*} .$$

A process is represented by a formula

$$\{ {\tilde{h}}_{1}^{*} , {\tilde{h}}_{2}^{*} , … , {\tilde{h}}_{m}^{*} \} = {M}^{T} \{ {\tilde{h}}_{1}^{L} , {\tilde{h}}_{2}^{L} , … , {\tilde{h}}_{n}^{L} \} .$$

A symbol L represents the number of layers of final graph convolution, a symbol m represents the number of service cluster embeddings, and a symbol M^{T} represents a transposition of the CAMe M in step (3.2.2).

Step (3.4) service cluster scores of the coarsened graph are generated according to service node scores {γ₁, γ₂, . . . , γₙ} before coarsening, and a result is assigned to

$${λ}_{{i}^{*}}^{*} .$$

A process is represented by a formula

$$\{ {λ}_{1}^{*} , {λ}_{2}^{*} , … , {λ}_{m}^{*} \} = {M}^{T} \{ {γ}_{1} , {γ}_{2} , … , {γ}_{n} \} .$$

A symbol M^{T} represents a transposition of the CAMe M in step (3.2.2), and a symbol γᵢ is an importance score of a service node vᵢ obtained by applying softmax to ϑⱼ in step (2.1.3.3).

Step 4, a dynamically changing focus service is captured, graph-level representation readout is performed, and a final output embedding is obtained according to a focus service representation and the graph-level representation readout, so as to obtain a probability of interaction between a target service and the user. A process includes:

Step (4.1) a focus service that is a service densely connected in the service network graph and represents a main requirement of the user is used.

Step (4.2) the dynamically changing focus service of the user is captured under a multi-head self-attention mechanism. A process includes:
step (4.2.1) the multi-head self-attention mechanism that is a variant of a self-attention mechanism and is capable of extracting information from different subspaces at different positions is used;
step (4.2.2) a cluster embedding matrix obtained in step (3.3) is represented by a symbol H, i.e.

$$H = \{ {\tilde{h}}_{1}^{*} , {\tilde{h}}_{2}^{*} , … , {\tilde{h}}_{m}^{*} \} ,$$

where a symbol

$${\tilde{h}}_{{i}^{*}}^{*}$$

represents an i*-th service cluster embedding; and
step (4.2.3) the dynamically changing focus service is captured, and a result is assigned to \tilde{h}_{Z}, where a process is represented by a formula \tilde{h}_{Z}=(head₁∥head₂∥ . . . ∥head_{h*})W^{O}, where a symbol h* represents the total number of heads of multiple heads, a symbol ∥ represents a splicing operation, a symbol head_{i**} represents an embedding representation learned from an i**-th head, a process of embedding representation learning is represented by a formula head_{i**}=ATTENTION(HW^{Q}*, HW^{K}*, HW^{V}*), symbols W^{O}, W^{Q}*, W^{K}*, and W^{V}* are learnable parameters, and the attention mechanism ATTENTION(⋅) is achieved through a scaling dot product and a softmax function.

Step (4.3) an average node embedding of all service nodes is computed according to an average function after forward computation of a propagation layer, a graph-level representation of the service network graph G before pooling is generated, and a result is assigned to \tilde{h}_{G}, where a process is represented by a formula

$${\tilde{h}}_{G} = Mean ( {γ}_{i}^{*} {\tilde{h}}_{i}^{L} , i ∈ G ) ,$$

where a symbol Mean represents the average function.

Step (4.4) a probability of interaction between the user and the target service is predicted, and a recommendation is made. A process includes:
step (4.4.1) \tilde{h}_{Z}, \tilde{h}_{G}, and a target service embedding \tilde{h}ₜ are spliced to obtain a composite embedding vector, then a composite embedding representation is learnt through a fully connected layer to obtain a probability of interaction between the user and the API service, and a result is assigned to \hat{r}, where a process is represented by a formula \hat{r}=Predict(\tilde{h}_{Z}∥\tilde{h}_{G}∥\tilde{h}ₜ∥\tilde{h}_{Z}⊙\tilde{h}ₜ∥\tilde{h}_{G}⊙\tilde{h}ₜ), where ∥ is a splicing symbol, a symbol ⊙ is a Hadamard product, and Predict(⋅) represents a prediction function having a two-layer feedforward neural network; and
step (4.4.2) a Bayesian loss function training model is constructed, and a loss function result is assigned to [symbol] _{BPR}, where a process is represented by a formula

$${ℒ}_{BPR} = {\sum }_{{i}^{*} ∈ {S}_{{u}_{i} ,} {j}^{*} ∉ {S}_{{u}_{i}}} - log σ ( {\hat{r}}_{{i}^{*}} - {\hat{r}}_{{j}^{*}} ) + η {‖ Θ ‖}_{2}^{2} ,$$

where a symbol Sᵤ_{ᵢ} represents the interaction sequence set of the user uᵢ, a symbol \hat{r}_{i*} represents a positive sample, and represents that the user interacts with the service, \hat{r}_{j*} represents that the user does not interact with the service, a symbol log represents a logarithmic operation, a symbol σ(⋅) represents a sigmoid function, and a symbol

$$η {‖ Θ ‖}_{2}^{2}$$

represents an L₂ regularizer parameterized by n, and has a function of preventing a problem of overfitting in a model learning process. The Bayesian loss function is a function that measures a difference between a predicted result and an actual result.

An actual effect of the invention is analyzed according to specific service data in the embodiment. An implementation process is as follows:

Step 1, data of Programmable Web from 2019 to 2020 is selected as an experimental data set. Specific information is shown in Table 1.

TABLE 1
Specific information table of experimental data set

| Item | Statistical information |
|---|---|
| Number of users | 3102 |
| Number of API services | 11930 |
| Number of interaction sequences | 6206 |

The data set includes 3102 users, 11930 pieces of API service data, and 6206 interaction sequences.

Step 2, the present disclosure (graph attention-augmented gaussian process for service recommendation (GAGP-SR)) is compared with 9 recommendation methods provided:
personalized hybrid collaborative filtering (PHCF): a hybrid collaborative filtering algorithm considering impact of user and service personalization is provided;
recency-aware collaborative filtering (RACF): similarity is computed based on direct comparison of attribute values, and attribute values of similar services and current services are compared to predict unknown values;
enhanced hybrid recommendation-matrix factorization (EHR-MF): implicit correlations between users and APIs are discovered based on joint matrix factorization and cognitive knowledge mining;
temporal-aware convolutional neural network for personalized recommendation (TC-PR): personalized recommendation is performed based on a time-aware convolutional neural network;
light graph convolutional network (LightGCN): feature transformation and nonlinear activation in a GCN are removed, and embedding learning of users and items is achieved by linear propagation on a user-item interaction graph;
graph neural network-based recommendation (GraphRec): interaction and rating information on a user-item interaction graph is captured based on a novel graph neural network framework;
query-aware sequential recommendation (Query-SeqRec): a recommendation is made according to a heterogeneous user sequence fusing query information and graph-based sequence enhancement;
feature-level deep self-attention network (FDSA): important features of items are adaptively selected according to an ordinary attention mechanism, and conversion modes of the items and feature sequences are modeled separately according to a deep self-attention network; and
self-attentive sequential recommendation (SASRec): the SASRec identifies related items in user interaction history at each time step for recommendation.

Step 3, accuracy of a service recommendation result is evaluated according to a hit ratio (HR) index. A computation method is as follows:

$$HR = \frac{1}{N} {\sum }_{i = 1}^{N} hit ( {v}_{i} ) .$$

The HR represents the accuracy of the recommendation result, hit(vᵢ) represents the service recommendation result, and N represents real interaction data between a user and an API service. The lager a value of the HR index is, the higher the accuracy of recommendation is. When a length of a service recommendation list is 10 or 20, the HR index may be recorded as HR@10 or HR@20.

Step 4, relevance of the service recommendation result is evaluated according to a normalized discounted cumulative gain (NDCG) index. A computation method is as follows:

$$NDCG = \frac{DCG}{IDCG} ; and$$

$$DCG = {\sum }_{B}^{b} \frac{{2}^{r ( b ) - 1}}{{log}_{2} ( b + 1 )} .$$

The NDCG represents the relevance of the recommendation result, a discounted cumulative gain (DCG) represents a weighted summation index of relevance scores in the recommendation result, B represents the length of the recommendation list, r(b) represents a relevance score of a b-th API service, and an ideal discounted cumulative gain (IDCG) represents the DCG in an ideal case. The larger a value of the NDCG index is, the higher quality of a sorting result is, and the more relevant the service recommendation result is to a user development requirement. When the length of the service recommendation list is 10 or 20, the NDCG index may be recorded as NDCG@10 or NDCG@20.

Step 5, 70% of experimental data in the data set is used as a training set, and the remaining 30% of data is used as a test set. An experimental effect is shown in Table 2. An optimal experimental index is bolded in Table 2.

TABLE 2
Experimental effect of embodiment

| Method | HR@10 | NDCG@10 | HR@20 | NDCG@20 |
|---|---|---|---|---|
| PHCF | 0.2431 | 0.2017 | 0.2746 | 0.2454 |
| RACF | 0.2574 | 0.2325 | 0.3074 | 0.2897 |
| EHR-MF | 0.3706 | 0.3424 | 0.4090 | 0.3953 |
| TC-PR | 0.3881 | 0.3876 | 0.4192 | 0.3966 |
| GraphRec | 0.3977 | 0.3965 | 0.4586 | 0.4108 |
| LightGCN | 0.4453 | 0.4511 | 0.4867 | 0.5053 |
| SASRec | 0.3230 | 0.3119 | 0.3782 | 0.3461 |
| FDSA | 0.4149 | 0.4086 | 0.4697 | 0.4503 |
| Query-SeqRec | 0.4739 | 0.4574 | 0.5076 | 0.5061 |
| GAGP-SR | 0.5027 | 0.4821 | 0.5259 | 0.5198 |

It can be seen through analysis of Table 2 that compared with the above methods, the recommendation result of the present disclosure is optimal. From the HR index and the NDCG index, the HR@10 index, the NDCG@10 index, the HR@20 index, and the NDCG@20 index of the present disclosure reach 0.5027, 0.4821, 0.5259, and 0.5198 respectively. Compared with optimal comparison methods on various indexes, the HR@10 index, the NDCG@10 index, the HR@20 index, and the NDCG@20 index are improved by 6.08%, 5.4%, 3.61%, and 2.71% respectively. Thus, it may be considered that the present disclosure has better recommendation accuracy.

An actual effect of the invention is analyzed according to specific service data in the embodiment. Comparison is described as follows:
step 1, an experimental data set is the same as that of the implementation solution;
step 2, five methods for recommending services are provided:
GAGP-SR: the method for recommending a service provided in the present disclosure is used;
without dual-level aware self-attention module (w/o DLA): a dual-level aware self-attention module is removed in the method for recommending a service provided in the present disclosure;
without cluster-aware self-attention module (w/o CA): a cluster-aware self-attention module in the dual-level aware self-attention module is removed in the method for recommending a service provided in the present disclosure;
without query-aware self-attention module (w/o QA): a query-aware self-attention module in the dual-level aware self-attention module is removed in the method for recommending a service provided in the present disclosure; and
without coarsening-based pooling for heterogeneous node graph (w/o CPHN): a graph pooling module taking heterogeneous node graph coarsening as a core is removed in the method for recommending a service provided in the present disclosure, and a differentiable pooling (DiffPool) method is used instead;
step 3, an HR index and a NDCG index which are the same as those of the implementation solution are selected as evaluation indexes; and
step 4, 70% of experimental data in the data set is used as a training set, and the remaining 30% of data is used as a test set. An experimental effect is shown in Table 3.

TABLE 3
Experimental effect of embodiment

| Model | HR@10 | NDCG@10 | HR@20 | NDCG@20 |
|---|---|---|---|---|
| w/o DLA | 0.4785 | 0.4644 | 0.4935 | 0.4863 |
| w/o CA | 0.4924 | 0.4785 | 0.5163 | 0.5037 |
| w/o QA | 0.4955 | 0.4726 | 0.5196 | 0.4982 |
| w/o CPHN | 0.4883 | 0.4695 | 0.5022 | 0.4950 |
| GAGP-SR | 0.5027 | 0.4821 | 0.5259 | 0.5198 |

It can be seen from Table 3 that a result obtained by removing the dual-level aware self-attention module is the worst, which is caused by introduction of a large amount of noise information caused by an indiscriminate aggregation service node embedding. The w/o DLA is improved by the w/o CA and the w/o QA, and results obtained by the w/o CA and the w/o QA are similar, which proves that the w/o CA and the w/o QA make significant contributions to improvement in model performance. The result of the w/o CPHN are lower than the result of the present disclosure by 2.86%, 2.61%, 4.49%, and 4.77% on the HR@10 index, the NDCG@10 index, the HR@20 index, and the NDCG@20 index respectively. This is because it is not easy for the DiffPool method to capture high-order dependencies of important information between nodes, thereby affecting recommendation performance. In summary, it may be considered that each module of the present disclosure has an indispensable effect on improvement in service recommendation performance.

The present disclosure mainly has the beneficial effects:
1, for massive API service data, the service embedding representation is learned in the dual-tower model, and semantic similarity between the API services is measured from multiple dimensions according to the multi-head weighted cosine similarity, thereby effectively improving construction quality of the service network graph;
2, the dual-level aware self-attention mechanism is designed in the graph convolutional network to restrict an amount of information transmitted between the service nodes, thereby maximizing utilization of important information, and improving quality of service embedding aggregation; and
3, service information of different categories is learned in the pooling layer separately according to the graph pooling operation taking heterogeneous graph coarsening as the core, so as to optimize the 2GCont, thereby better capturing high-order association between services, and improving accuracy of service recommendation.

The content described in the embodiments of the description is merely an enumeration of the implementation forms of the inventive concept and is used merely for illustrative purposes. The scope of protection of the present disclosure should not be regarded as being limited to the specific forms described in the embodiment, the scope of protection of the present disclosure also extends to equivalent technical means conceivable to those of ordinary skill in the art according to the concept of the present disclosure.

What is claimed is:

1. A method for recommending a Web service based on a graph attention convolutional network and graph pooling, comprising:
step 1, creating a service data set, acquiring service interaction data, and constructing a service network graph according to a dual-tower model;
step 2, for a graph structure in the service network graph, designing a dual-level aware self-attention mechanism to aggregate service embedding vectors, and extracting service features according to the graph convolutional network;
step 3, further extracting important service information according to the graph pooling taking heterogeneous node graph coarsening as a core, wherein heterogeneous nodes refer to nodes of various types existing in the service network graph; and
step 4, capturing a dynamically changing focus service, and performing graph-level representation readout, wherein the focus service is a service densely connected in the service network graph and represents a main requirement of a user, and obtaining a final output embedding according to a focus service representation and the graph-level representation readout, so as to obtain a probability of interaction between a target service and the user, wherein
the step 1 comprises:
step (1.1) using the dual-tower model that is a deep learning framework in which two different data features are learnt from two towers respectively and then similarity between two pieces of input data is measured;
step (1.2) creating the service data set, crawling user information and an application programming interface (API) service from a related website, and analyzing and sorting a collected result to obtain the service data set, wherein the service data set comprises the following information:
step (1.2.1) a user: a developer calling the API service, which is represented by a symbol uᵢ; and
step (1.2.2) the API service: an interface that allows communication and data exchange between different software applications, which is a recommended object in service recommendation and is represented by a symbol aᵢ;
step (1.3) constructing an interaction sequence set, and acquiring interaction information between the user and the service on a time stamp from the service data set to form an interaction sequence, wherein a process comprises:
step (1.3.1) constructing the interaction sequence, which is represented by a symbol seq; and
step (1.3.2) traversing the service data set, and putting the service at into seq under the condition that an interaction behavior exists between the user uⱼ and the service aᵢ;
step (1.4) sorting interaction sequences according to time stamps to form the interaction sequence set, wherein a process comprises:
step (1.4.1) constructing the interaction sequence set, which is represented by a symbol S; and
step (1.4.2) arranging all the interaction sequences according to a time sequence to obtain the interaction sequence set; and
step (1.5) constructing the service network graph, and converting the interaction sequence set into the service network graph through the dual-tower model, wherein in step (1.5), a process of constructing the service network graph comprises:
step (1.5.1) defining the service network graph, which is represented by a symbol G, wherein a node set of G is represented by a symbol V, an edge set of G is represented by E, and an adjacency matrix is represented by A′;
step (1.5.2) converting aᵢ in step (1.3.2) into a node vᵢ; and
step (1.5.3) inputting API service nodes into the dual-tower model for feature learning, computing similarity between services according to multi-head weighted cosine similarity, and then constructing the service network graph based on the similarity; and
the step 2 comprises:
step (2.1) designing the dual-level aware self-attention mechanism in the graph convolutional network, wherein a process of designing the dual-level aware self-attention mechanism comprises:
step (2.1.1) using the dual-level aware self-attention mechanism comprising a cluster-aware self-attention mechanism and a query-aware self-attention mechanism;
step (2.1.2) designing the cluster-aware self-attention mechanism, wherein a process comprises:
step (2.1.2.1) assuming that a cluster is formed by taking a target node vᵢ as an expected median, and k** hop neighbors of the target node are taken as an acceptance domain of the cluster, acquiring a normalized activity degree of the target node vᵢ, and assigning a result to r*ᵢ, wherein a process is represented by a formula
$${r}_{i}^{*} = \frac{log ( \vert {𝒩}_{{v}_{i}} \vert )}{\frac{1}{\vert {V}^{*} \vert} {\sum }_{{v}_{{j}^{* ∈ V}}} * log ( \vert {𝒩}_{{v}_{{j}^{*}}} \vert ) 1} ,$$
wherein a symbol |V*| represents the total number of first-order neighbors of all nodes, a symbol [symbol] represents a set of first-order neighbors of the node vᵢ, a symbol v_{j*} represents other nodes apart from the node vᵢ, the expected median is a pre-assumed central value in each cluster, an activity degree of the nodes refers to a frequency of interaction between the nodes and the user, and normalization is a data processing technology and aims to convert data having different features into a unified standard for subsequent analysis and processing; and
step (2.1.2.2) acquiring a central point of each cluster according to a k-medoids algorithm, wherein a process comprises:
step (2.1.2.2.1) randomly selecting k** node embeddings from an API service embedding as an initial cluster center;
step (2.1.2.2.2) computing an Euclidean distance from each API service node embedding vector
$${\tilde{h}}_{j}^{l}$$
to the central point
$${\tilde{h}}_{{i}_{c}}^{l}$$
of each cluster, and assigning a result to
$$d ( {\tilde{h}}_{j}^{l} , {\tilde{h}}_{{i}_{c}}^{l} ) ,$$
wherein a process is represented by a formula
$$d ( {\tilde{h}}_{j}^{l} , {\tilde{h}}_{{i}_{c}}^{l} ) = \sqrt{{\sum }_{j = 1}^{n} {( {\tilde{h}}_{j}^{l} , {\tilde{h}}_{{i}_{c}}^{l} )}^{2}} ,$$
wherein a symbol i_{c} represents that a node is the central point of the cluster, and a symbol n represents the total number of API service node embeddings;
step (2.1.2.2.3) assigning each API service node to a cluster nearest to the API service node according to
$$d ( {\tilde{h}}_{j}^{l} , {\tilde{h}}_{{i}_{c}}^{l} )$$
of step (2.1.2.2.2);
step (2.1.2.2.4) computing an overall deviation, and assigning a result to S*, wherein a process is represented by a formula
$${S}^{*} = {\sum }_{k = 1}^{{K}^{′}} {\sum }_{{\tilde{h}}_{j}^{l} ∈ {C}_{{i}_{c}}} d ( {\tilde{h}}_{j}^{l} , {\tilde{h}}_{{i}_{c}}^{l} ) ,$$
wherein a symbol K′ represents the total number of the clusters, and a symbol Cᵢ_{_{c}} represents a node embedding set of an i_{c}-th cluster;
step (2.1.2.2.5) repeating steps (2.1.2.2.1)-(2.1.2.2.4) until S* in step (2.1.2.2.4) is no longer changed; and
step (2.1.2.2.6) computing an API service cluster-aware self-attention weight, wherein a normalized user activity degree participates in computation in a non-destructive way, and assigning a result to aᵢ, wherein a process is represented by a formula
$${α}_{i} = softmax ( \frac{{W}_{{q}^{**}}^{″} {\tilde{h}}_{{i}_{c}}^{l} \cdot {( {W}_{k}^{″} {\tilde{h}}_{{i}_{c}}^{l} )}^{T}}{\sqrt{d}} ) \cdot {r}_{i}^{*} {W}_{v}^{″} {\tilde{h}}_{i}^{l} ,$$
wherein symbols W″_{q**}, W″ₖ, and W″ᵥ represent learnable weight matrices,
$${( {W}_{k}^{″} {\tilde{h}}_{{i}_{c}}^{l} )}^{T}$$
represents a transposition of
$${W}_{k}^{″} {\tilde{h}}_{{i}_{c}}^{l} ,$$
\sqrt{d} is a scaling factor and prevents a result of an inner product from being excessively large, softmax is an activation function, the non-destructive way refers to only serving as an influence coefficient of
$${W}_{k}^{″} {\tilde{h}}_{i}^{l}$$
without influencing
$${W}_{{q}^{**}}^{″} {\tilde{h}}_{{i}_{c}}^{l} and {W}_{k}^{″} {\tilde{h}}_{{i}_{c}}^{l} ,$$
and more efficient modeling is achieved by controlling an information source of a self-attention component; and
step (2.1.3) designing the query-aware self-attention mechanism, wherein a process of designing the query-aware self-attention mechanism comprises:
step (2.1.3.1) representing an API service embedding vector queried by the user for an i′-th time by a symbol h^{q′}^{_{i′}}, wherein a superscript q′_{i′} represents that a current service vector is a query vector of the user;
step (2.1.3.2) representing user query service embedding representations sorted according to time by a symbol Q={h^{q′}^{₁}, h^{q′}^{₂}, . . . , h^{q′}^{_{t*}}}, wherein t* represents a length of time;
step (2.1.3.3) computing attention scores of Q at different times, and assigning a result to [symbol] , wherein a process is represented by a formula
$${ϑ}_{j} = Attention ( \frac{{W}_{q} {h}^{{q}_{j}^{′}} \cdot {( {W}_{k} {h}^{{q}_{j}^{′}} )}^{T}}{\sqrt{{d}^{′}}} ) ,$$
wherein symbols W_{q} and Wₖ are trainable time parameters,
$${( {W}_{k} {h}^{{q}_{j}^{′}} )}^{T}$$
represents a transposition of Wₖh^{q′}^{ⱼ}, a symbol d′ represents a query representation dimension, \sqrt{ } is a root operation, and Attention is a double-layer feedforward neural network by taking a leaky rectified linear unit (LeakyReLU) as an activation function; and
step (2.1.3.4) computing an attention weight in an API service node aggregation in a non-destructive way, and assigning a result to βⱼ, wherein a process is represented by a formula
$${β}_{j} = softmax ( \frac{{ϑ}_{j} {W}_{q}^{′} * {\tilde{h}}_{j}^{l} \cdot {( {ϑ}_{j} {W}_{k}^{′} {\tilde{h}}_{j}^{l} )}^{T}}{\sqrt{d}} ) \cdot {W}_{v}^{′} {\tilde{h}}_{t}^{l} ,$$
wherein symbols
$${W}_{q}^{′} * , {W}_{k}^{′} , and {W}_{v}^{l}$$
represent learnable weight matrices, \sqrt{d} is a scaling factor and prevents a result of an inner product from being excessively large,
$${\tilde{h}}_{j}^{l}$$
represents a source node,
$${\tilde{h}}_{t}^{l}$$
represents the target node, softmax is an activation function, the non-destructive way refers to only serving as influence coefficients of
$${W}_{q}^{′} * {\tilde{h}}_{j}^{l} and {W}_{k}^{′} {\tilde{h}}_{j}^{l}$$
without influencing
$${W}_{v}^{′} {\tilde{h}}_{t}^{l} ,$$
and more effective modeling is achieved by controlling the information source of the self-attention component.

2. The method for recommending a Web service based on a graph attention convolutional network and graph pooling according to claim 1, wherein the step (1.5.3) comprises:
step (1.5.3.1) converting any two API service nodes into embedding vectors hᵢ and hⱼ through one-hot encoding, wherein the one-hot encoding is an encoding method for converting classification variables into a numerical format;
step (1.5.3.2) encoding a description document and tag information of the API service in the interaction sequence;
step (1.5.3.3) fusing the API service embedding vectors and semantic vectors to obtain a service vector \tilde{h}ᵢ comprising semantic information, wherein a process is represented by a formula \tilde{h}ᵢ= [symbol] _{fusion}(hᵢ, sᵢ|θᵢ, ωᵢ), wherein a symbol [symbol] _{fusion}(⋅) represents a fusion function, the fusion function combines two features into a single representation according to a weighted sum method, sᵢ represents the semantic vector of the API service, and symbols θᵢ and ωᵢ are fusion function parameters;
step (1.5.3.4) measuring similarity between the two embedding vectors according to weighted cosine similarity, and assigning a result to sim_{i,j}, wherein a process is represented by a formula sim_{i,j}=cos(w⊙\tilde{h}ᵢ, w⊙\tilde{h}ⱼ), wherein a symbol cos (⋅) represents use of a cosine similarity measurement method, a symbol w represents a learnable weight vector, a symbol ⊙ represents a Hadamard product, the weighted cosine similarity is a method for measuring similarity between two vectors, and a concept of a weight is added into the weighed cosine similarity based on cosine similarity, so as to better reflect importance of different features;
step (1.5.3.5) extending a weighted cosine metric function to multi-head weighted cosine similarity metric by repeating ψ, computing ψ independent similarity matrices according to the similarity metric function, then taking an average value as final similarity of the two embedding vectors, and assigning a result to
$${sim}_{i , j}^{*} ,$$
wherein a process is represented by formulas
$${sim}_{i , j}^{*} = cos ( {w}_{δ} ⊙ {\tilde{h}}_{i} , {w}_{δ} ⊙ {\tilde{h}}_{j} ) and {sim}_{i , j}^{*} = \frac{1}{δ} {\sum }_{δ = 1}^{ψ} s i {m}_{i , j}^{δ} ,$$
wherein a symbol
$$s i {m}_{i , j}^{δ}$$
represents similarity of a δ-th similarity matrix, a symbol w_{δ} represents a learnable weight vector of the δ-th similarity matrix, a symbol ψ represents the total number of heads of multi-head extension, each head captures different semantic information, and the multi-head weighted cosine similarity metric refers to computing weighted cosine similarity between vectors in multiple different dimensions;
step (1.5.3.6) connecting an edge between two API service nodes vᵢ and vⱼ having similarity in step (1.5.3.5), representing the edge by a symbol (vᵢ, e_{i,j}, vⱼ), so as to construct an initial service network graph G′, setting an element A′ᵥ_{ᵢ}ᵥ_{ⱼ} of the adjacency matrix A′ as 1, and setting A′ᵥ_{_{m*}}_{,v}_{_{n*}} in the adjacency matrix as 0 for two API service nodes v_{m*} and v_{n*} having no edge connection; and
step (1.5.3.7) performing sparsification on G′ through ε-sparsity to ensure subsequent graph convolution in a most relevant aspect of a graph, and then constructing a service network graph G after sparsification.

3. The method for recommending a Web service based on a graph attention convolutional network and graph pooling according to claim 2, wherein the step (1.5.3.2) comprises:
step (1.5.3.2.1) using the description document of the API service that is a document for recording a function, a characteristic and interface information of the service;
step (1.5.3.2.2) using a service tag that is a short text for identifying a type of a service function;
step (1.5.3.2.3) performing word segmentation and stop word removal on description documents and tag information of any two API services; and
step (1.5.3.2.4) encoding the description documents and the tag information of the processed two API services to obtain semantic vectors Sᵢ and Sⱼ according to a bidirectional encoder representations from transformers (BERT) model; and
the step (1.5.3.7) comprises:
step (1.5.3.7.1) using ε-sparsity belonging to a model compression technology that improves operation efficiency of the model by making the adjacency matrix A′ sparse by discarding elements less than a threshold ε; and
step (1.5.3.7.2) extracting a symmetric sparse non-negative adjacency matrix from
$$s i {m}_{i , j}^{*}$$
of step (1.5.3.5), and assigning a result to A, wherein a process is represented by a formula
$${A}_{i , j} = \{ \begin{matrix}1 , & {sim}_{i , j}^{*} >= {Rank}_{ε {n}^{2}} ( s i {m}^{*} ) \\ 0 , & other cases\end{matrix} ,$$
wherein a symbol A_{i,j} represents an element in an i-th row and a j-th column in A, a symbol Rank_{εn}_{²}(sim*) represents a εn²-th largest value in ranking of a return similarity matrix sim*, a symbol n represents the number of service nodes, a symbol n² is a square operation, and a symbol ε controls overall sparsity of G.

4. The method for recommending a Web service based on a graph attention convolutional network and graph pooling according to claim 1, wherein the step 2 further comprises:
step (2.2) adjusting a weight of a service embedding vector in an information aggregation according to the dual-level aware self-attention mechanism, and updating an embedding representation through a graph convolution operation.

5. The method for recommending a Web service based on a graph attention convolutional network and graph pooling according to claim 2, wherein the step 2 further comprises:
step (2.2) adjusting a weight of a service embedding vector in an information aggregation according to the dual-level aware self-attention mechanism, and updating an embedding representation through a graph convolution operation.

6. The method for recommending a Web service based on a graph attention convolutional network and graph pooling according to claim 3, wherein the step 2 further comprises:
step (2.2) adjusting a weight of a service embedding vector in an information aggregation according to the dual-level aware self-attention mechanism, and updating an embedding representation through a graph convolution operation.

7. The method for recommending a Web service based on a graph attention convolutional network and graph pooling according to claim 4, wherein a process of embedding updating of the step (2.2) comprises:
step (2.2.1) computing an attention weight when the service node embedding is updated according to the dual-level aware self-attention mechanism, and assigning a result to Eᵢⱼ, wherein a process is represented by a formula Eᵢⱼ=λαᵢ+ (1−λ)βⱼ, wherein a symbol λ represents a balance coefficient that balances a ratio between αᵢ and βⱼ;
step (2.2.2) inputting an API service node embedding matrix
$$\{ {\tilde{h}}_{1}^{l} , {\tilde{h}}_{2}^{l} , … , {\tilde{h}}_{n}^{l} \} , {\tilde{h}}_{i}^{l} ∈ {ℝ}^{d}$$
into an l+1-th layer, wherein a symbol n represents the number of node embeddings, ∈ is a mathematical symbol, and represents a belonging relation, [symbol] ^{d} represents a set comprising α-dimensional real vectors, and α is an embedding size of the nodes; and
step (2.2.3) computing a service embedding representation of the l+1-th layer, and assigning a result to
$${\tilde{h}}_{i}^{l + 1} ,$$
wherein a process is represented by a formula
$${\tilde{h}}_{i}^{l + 1} = {\tilde{h}}_{i}^{l} + {\sum }_{{v}_{k} ∈ {ℳ}_{i}} \frac{1}{\vert {ℳ}_{i} \vert} {E}_{i j} {\tilde{h}}_{k}^{l} ,$$
wherein a symbol [symbol] represents a set of neighbor nodes of a node vᵢ, Σ is a summation symbol, and vₖ represents a neighbor node of vᵢ.

8. The method for recommending a Web service based on a graph attention convolutional network and graph pooling according to claim 5, wherein a process of embedding updating of the step (2.2) comprises:
step (2.2.1) computing an attention weight when the service node embedding is updated according to the dual-level aware self-attention mechanism, and assigning a result to Eᵢⱼ, wherein a process is represented by a formula Eᵢⱼ=λαᵢ+(1−λ)βⱼ, wherein a symbol λ represents a balance coefficient that balances a ratio between αᵢ and βⱼ;
step (2.2.2) inputting an API service node embedding matrix
$$\{ {\tilde{h}}_{1}^{l} , {\tilde{h}}_{2}^{l} , … , {\tilde{h}}_{n}^{l} \} , {\tilde{h}}_{i}^{l} ∈ {ℝ}^{d}$$
into an l+1-th layer, wherein a symbol n represents the number of node embeddings, ∈ is a mathematical symbol, and represents a belonging relation, [symbol] ^{d} represents a set comprising α-dimensional real vectors, and α is an embedding size of the nodes; and
step (2.2.3) computing a service embedding representation of the l+1-th layer, and assigning a result to
$${\tilde{h}}_{i}^{l + 1} ,$$
wherein a process is represented by a formula
$${\tilde{h}}_{i}^{l + 1} = {\tilde{h}}_{i}^{l} + {\sum }_{{v}_{k} ∈ {ℳ}_{i}} \frac{1}{\vert {ℳ}_{i} \vert} {E}_{i j} {\tilde{h}}_{k}^{l} ,$$
wherein a symbol [symbol] represents a set of neighbor nodes of a node vᵢ, Σ is a summation symbol, and vₖ represents a neighbor node of vᵢ.

9. The method for recommending a Web service based on a graph attention convolutional network and graph pooling according to claim 6, wherein a process of embedding updating of the step (2.2) comprises:
step (2.2.1) computing an attention weight when the service node embedding is updated according to the dual-level aware self-attention mechanism, and assigning a result to Eᵢⱼ, wherein a process is represented by a formula Eᵢⱼ=λαᵢ+ (1−λ)βⱼ, wherein a symbol λ represents a balance coefficient that balances a ratio between αᵢ and βⱼ;
step (2.2.2) inputting an API service node embedding matrix
$$\{ {\tilde{h}}_{1}^{l} , {\tilde{h}}_{2}^{l} , … , {\tilde{h}}_{n}^{l} \} , {\tilde{h}}_{i}^{l} ∈ {ℝ}^{d}$$
into an l+1-th layer, wherein a symbol n represents the number of node embeddings, ∈ is a mathematical symbol, and represents a belonging relation, [symbol] ^{d} represents a set comprising-dimensional real vectors, and α is an embedding size of the nodes; and
step (2.2.3) computing a service embedding representation of the l+1-th layer, and assigning a result to
$${\tilde{h}}_{i}^{l + 1} ,$$
wherein a process is represented by a formula
$${\tilde{h}}_{i}^{l + 1} = {\tilde{h}}_{i}^{l} + {\sum }_{{v}_{k} ∈ {ℳ}_{i}} \frac{1}{\vert {ℳ}_{i} \vert} {E}_{i j} {\tilde{h}}_{k}^{l} ,$$
wherein a symbol [symbol] represents a set of neighbor nodes of a node vᵢ, Σ is a summation symbol, and vₖ represents a neighbor node of vᵢ.

10. The method for recommending a Web service based on a graph attention convolutional network and graph pooling according to claim 1, wherein the step 3 comprises:
step (3.1) acquiring a heterogeneous API service node embedding matrix, wherein a process comprises:
step (3.1.1) dividing the node embedding matrix into F submatrices according to types of the API service nodes, wherein a node embedding matrix of an i′-th type is represented as
$${Y}_{{i}^{{′}^{L}}} = \{ {\tilde{h}}_{1}^{L} , {\tilde{h}}_{2}^{L} , … , {\tilde{h}}_{{n}^{′}}^{L} \} ,$$
wherein a symbol n′ represents the total number of node embeddings of the type;
step (3.1.2) learning the node embeddings of each type in a graph pooling layer, and assigning a result to
$${T}_{{i}^{′}}^{L} ,$$
wherein a process is represented by a formula
$${T}_{{i}^{′}}^{L} = PoolGNN ( {Y}_{{i}^{′}}^{L} ; {Θ}_{{i}^{′}}^{L} ) ,$$
wherein a symbol
$${T}_{{i}^{′}}^{L}$$
represents a pooling matrix or an i′-th node type, a symbol
$${Θ}_{{i}^{′}}^{L}$$
represents a parameter set of a pooled graph neural network (GNN), and a symbol PoolGNN(⋅) represents that a graph pooling operation is currently performed;
step (3.1.3) compressing
$${T}_{{i}^{′}}^{L}$$
in step (3.1.2) to obtain a summary matrix, and assigning a result to
$$A {g}_{{i}^{′}}^{L} ,$$
wherein a process is represented by a formula
$$A {g}_{{i}^{′}}^{L} = softmax ( {W}_{{i}^{′}}^{L} {T}_{{i}^{′}}^{L} + {B}_{{i}^{′}}^{L} ) ,$$
wherein symbols
$${W}_{{i}^{′}}^{L} and {B}_{{i}^{′}}^{L}$$
are learnable parameters, and softmax(⋅) is an activation function;
step (3.1.4) obtaining an aligned service node embedding pooling matrix
$${P}_{{i}^{′}}^{L} and {Ag}_{{i}^{′}}^{L}$$
according to a zero-padding technology, wherein the zero-padding technology refers to adding a zero element at an edge of data to maintain stability of an embedding dimension of the summary matrix; and
step (3.1.5) providing a node embedding aggregator to perform node embedding aggregation, and assigning a result to
$${Y}_{{i}^{′}}^{L + 1} ,$$
wherein a process is represented by a formula
$${Y}_{{i}^{′}}^{L + 1} = {P}_{{i}^{′}}^{{L}^{⊤}} {Y}_{{i}^{′}}^{L + 1} ,$$
and then, splicing node embedding matrices of various types to obtain a complete node embedding matrix
$${Y}^{L + 1} = concat ( {Y}_{1}^{L + 1} , {Y}_{2}^{L + 1} , … , {Y}_{F}^{L + 1} ) = \{ {\tilde{h}}_{1}^{L + 1} , {\tilde{h}}_{2}^{L + 1} , … , {\tilde{h}}_{N}^{L + 1} \} ,$$
wherein a symbol concat(⋅) represents that a splicing operation is currently performed, a symbol
$${P}_{{i}^{′}}^{{L}^{T}}$$
represents a transposition of
$${P}_{{i}^{′}}^{L}$$
in step (3.1.4), a subscript N represents the total number of node embeddings after pooling, and a superscript L+1 represents that the current node embedding matrix is a matrix through heterogeneous pooling;
step (3.2) coarsening the graph according to global graph content (2GCont) and a cross-attention mechanism (CAMe), wherein a process of graph coarsening comprises:
step (3.2.1) computing a global graph content matrix, and assigning a result to C, wherein a process is represented by a formula
$$C = \{ {\tilde{h}}_{1}^{L + 1} , {\tilde{h}}_{2}^{L + 1} , … , {\tilde{h}}_{N}^{L + 1} \} X ,$$
wherein a symbol X represents a parameterized weight matrix;
step (3.2.2) computing the CAMe, and assigning a result to M, wherein a process is represented by a formula Mᵢⱼ=LeakyReLU(a^{T}[C_{(i,⋅)}∥C_{(⋅,j)}]), wherein a symbol a^{T} represents a trainable shared attention parameter, a symbol C_{(i,⋅)}∈ [symbol] ^{N} represents a service node embedding having a dimension of N before coarsening, C_{(⋅,j)}∈ [symbol] ^{N′} represents a service cluster embedding having a dimension of N′ after coarsening, and [⋅∥⋅] represents a splicing operation; and
step (3.2.3) normalizing Mᵢⱼ, and assigning a result to M, wherein a process is represented by a formula
$$M = \frac{exp ( {M}_{ij} )}{{\sum }_{g ∈ {N}^{′}} exp ( {M}_{ig} )} ,$$
wherein a symbol exp is a natural exponent operation, a symbol M_{ig} represents all elements in an i-th row, and a symbol N′ represents the number of columns in an i-th row of M;
step (3.3) generating a service cluster embedding of a coarsened graph according to the service node embedding matrix
$$\{ {\tilde{h}}_{1}^{L} , {\tilde{h}}_{2}^{L} , … , {\tilde{h}}_{n}^{L} \}$$
before pooling, and assigning a result to
$${\tilde{h}}_{{i}^{*}}^{*} ,$$
wherein a process is represented by a formula
$$\{ {\tilde{h}}_{1}^{*} , {\tilde{h}}_{2}^{*} , … , {\tilde{h}}_{m}^{*} \} = {M}^{T} \{ {\tilde{h}}_{1}^{L} , {\tilde{h}}_{2}^{L} , … , {\tilde{h}}_{n}^{L} \} ,$$
wherein a symbol L represents the number of layers of final graph convolution, a symbol m represents the number of service cluster embeddings, and a symbol M^{T} represents a transposition of the CAMe M in step (3.2.2); and
step (3.4) generating service cluster scores of the coarsened graph according to service node scores {γ₁, γ₂, . . . , γₙ} before coarsening, and assigning a result to
$${λ}_{{i}^{*}}^{*} ,$$
wherein a process is represented by a formula
$$\{ {λ}_{1}^{*} , {λ}_{2}^{*} , … , {λ}_{m}^{*} \} = {M}^{T} \{ {γ}_{1} , {γ}_{2} , … , {γ}_{n} \} ,$$
wherein a symbol M^{T} represents a transposition of the CAMe M in step (3.2.2), and a symbol γᵢ is an importance score of a service node vᵢ obtained by applying softmax to [symbol] in step (2.1.3.3).

11. The method for recommending a Web service based on a graph attention convolutional network and graph pooling according to claim 10, wherein the step 4 comprises:
step (4.1) using a focus service that is a service densely connected in the service network graph and represents a main requirement of the user;
step (4.2) capturing the dynamically changing focus service of the user under a multi-head self-attention mechanism, wherein a process comprises:
step (4.2.1) using the multi-head self-attention mechanism that is a variant of a self-attention mechanism and is capable of extracting information from different subspaces at different positions;
step (4.2.2) representing a cluster embedding matrix obtained in step (3.3) by a symbol H, i.e.
$$H = \{ {\tilde{h}}_{1}^{*} , {\tilde{h}}_{2}^{*} , … , {\tilde{h}}_{m}^{*} \} ,$$
wherein a symbol
$${\tilde{h}}_{{i}^{*}}^{*} ,$$
represents an i*-th service cluster embedding; and
step (4.2.3) capturing the dynamically changing focus service, and assigning a result to \acute{h}_{Z}, wherein a process is represented by a formula \tilde{h}_{Z}=(head₁∥head₂∥ . . . ∥head_{h*})W^{O}, wherein a symbol h* represents the total number of heads of multiple heads, a symbol ∥ represents a splicing operation, a symbol head_{i**} represents an embedding representation learned from an i**-th head, a process of embedding representation learning is represented by a formula head_{i**}=ATTENTION(HW^{Q}*, HW^{K}*, HW^{V}*), symbols W^{O}, W^{Q}*, W^{K}*, and W^{V}* are learnable parameters, and the attention mechanism ATTENTION(⋅) is achieved through a scaling dot product and a softmax function;
step (4.3) computing an average node embedding of all service nodes according to an average function after forward computation of a propagation layer, generating a graph-level representation of the service network graph G before pooling, and assigning a result to \tilde{h}_{G}, wherein a process is represented by a formula
$${\tilde{h}}_{G} = Mean ( {γ}_{i}^{*} {\tilde{h}}_{i}^{L} , i ∈ G ) ,$$
wherein a symbol Mean represents the average function; and
step (4.4) predicting a probability of interaction between the user and the target service, and making a recommendation, wherein a process comprises:
step (4.4.1) splicing \tilde{h}_{Z}, \tilde{h}_{G}, and a target service embedding \tilde{h}ₜ to obtain a composite embedding vector, then learning a composite embedding representation through a fully connected layer to obtain a probability of interaction between the user and the API service, and assigning a result to \hat{r}, wherein a process is represented by a formula \hat{r}=Predict(\tilde{h}_{Z}∥\tilde{h}_{G}∥\tilde{h}ₜ∥\tilde{h}_{Z}⊙\tilde{h}ₜ∥\tilde{h}_{G}⊙\tilde{h}ₜ), wherein ∥ is a splicing symbol, a symbol ⊙ is a Hadamard product, and Predict(⋅) represents a prediction function having a two-layer feedforward neural network; and
step (4.4.2) constructing a Bayesian loss function training model, and assigning a loss function result to [symbol] _{BPR}, wherein a process is represented by a formula
$${ℒ}_{BPR} = {\sum }_{{i}^{*} ∈ {S}_{{u}_{i}} , {j}^{*} ∉ {S}_{{u}_{i}}} - log σ ( {\hat{r}}_{{i}^{*}} - {\hat{r}}_{{j}^{*}} ) + η {‖ Θ ‖}_{2}^{2} ,$$
wherein a symbol Sᵤ_{ᵢ} represents the interaction sequence set of the user uᵢ, a symbol \hat{r}_{i*} represents a positive sample, and represents that the user interacts with the service, \hat{r}_{j*} represents that the user does not interact with the service, a symbol log represents a logarithmic operation, a symbol σ(⋅) represents a sigmoid function, and a symbol
$$η {‖ Θ ‖}_{2}^{2}$$
represents an L₂ regularizer parameterized by η, and has a function of preventing a problem of overfitting in a model learning process.
